(19) United States
(12) Patent Application Publication
(10) Pub. No.: US 2026/0357960 A1
(43) Pub. Date: Nov. 12, 2026

(54) Integrated System for Hanging and Providing Power to Lighted Outdoor Decorative Item

(71) Applicants: David Simpson, Chatham, NJ (US); Linda Kennyhertz, Chatham, NJ (US)

(72) Inventors: David Simpson, Chatham, NJ (US); Linda Kennyhertz, Chatham, NJ (US)

(21) Appl. No.: 19/662,542

(22) Filed: Apr. 29, 2026

Related U.S. Application Data
(60) Provisional application No. 63/804,249, filed on May 12, 2025.

(51) Int. Cl. F21S 9/02; F21V 23/00; F21V 23/06; F21V 33/00; H02J 50/00; H02J 50/10; H02J 50/90

(52) U.S. Cl. CPC F21S 9/02; F21V 23/001; F21V 23/06; F21V 33/0016; H02J 50/005; H02J 50/10; H02J 50/90

(57) ABSTRACT

An integrated system for hanging an outdoor lighted decorative item on a door of a structure that has exterior exposure, and providing power to the item from indoors that includes a power source, a decorative item support structure that has an intermediate portion that is configured to hang on the top of the door, an exterior portion that extends in a first direction from the intermediate portion down along the exterior of the door and comprises a first support portion that is configured to carry the lighted decorative item, and an interior portion that extends in a second direction from the intermediate portion into the interior of the structure proximate the door and comprises a second support portion that is configured to support the power source, and electrical wiring that carries electrical power from the power source to the lighted decorative item.

### CROSS-REFERENCE TO RELATED APPLICATION

This application claims priority of Provisional Application 63/804,249 filed on May 12, 2025, the disclosure of which is incorporated by reference herein.

### BACKGROUND

This innovation—in part—addresses issues associated with Lighted Door Wreaths and other electrically powered outdoor ornamentation—particularly ornamentation hung on—but not limited to—a door; delivering power reliably to the miniature electric lights of outdoor ornamentation such as wreaths.

### SUMMARY

The innovations embodied herein address the limitations of the current methods of powering electric lights—and other such power sinks—in a number of applications in structures intended for living and working.

In particular, this innovation provides a means for the occupants of a building to safely and easily open and close the door—as desired and as would be typical—while also delivering a reliable source of power to the Lighted Door Wreath that is hung on the door, without running an AC power cord directly to the wreath, without employing a DC battery pack self-contained within the wreath (or located elsewhere outside proximate the wreath) and without the use of self-contained photovoltaic cells.

This innovation comprises an over-the-door wreath hanger—or other such hanger of powered outdoor ornamentation-that carries power from the inside of the building to the wreath—or other such ornamentation—on the outside, be that via-but not limited to—induction, or disposable batteries or rechargeable/swapable battery packs with a charger or AC-to-DC power adapter.

The innovations taught herein can also be applied to other power sinks, form-factors and embodiments beyond powering electric lights and include but are not limited to powering sound-generating devices, mechanical devices and security devices. The power sink may comprise a plurality of lights, where the lights are carried by a wreath. The power sink may also comprise at least one of a lamp, a sign, an electric candle, an electric lantern or an animated character of some sort.

In one aspect, an integrated system for hanging an outdoor lighted decorative item on a door of a structure that has exterior exposure, and providing power to the item from indoors includes a power source, a decorative item support structure that has an intermediate portion that is configured to hang on the top of the door, an exterior portion that extends in a first direction from the intermediate portion down along the exterior of the door and comprises a first support portion that is configured to carry the lighted decorative item, and an interior portion that extends in a second direction from the intermediate portion into the interior of the structure proximate the door and comprises a second support portion that is configured to support the power source and electrical wiring that carries electrical power from the power source to the lighted decorative item.

In an example the power source comprises a DC battery pack. In an example the DC battery pack comprises rechargeable batteries. In an example the power source comprises an inductive power receiver. In an example the system also includes an inductive power transmitter that is configured to be held close to the inductive power receiver when the door is closed. In an example the inductive power receiver and the inductive power transmitter are contained within separate non-conductive enclosures that are configured to be close to each other when the door is closed. In an example the inductive power transmitter is configured to be supported by the head jamb of the door casing.

In an example the first support portion comprises a hook. In an example the decorative item support structure is an integral plastic member. In an example the intermediate portion is generally “U” shaped such that it sits over the top of the door and extends downward along both the interior and exterior of the door. In an example the second support portion comprises spaced horizontal parts that are configured to be located above and below a battery pack. In an example the support structure defines a groove that extends from the second support portion to the first support portion, wherein the electrical wiring is located in the groove. In an example the electrical wiring comprises a plug that is configured to mate with a jack carried by the decorative item.

### BRIEF DESCRIPTION OF THE DRAWINGS

FIG. 1 is a schematic diagram of an over-the-door hanger or holder for a decorative lighted item such as a wreath.

FIG. 2 is a schematic diagram of an over-the-door hanger or holder for a decorative lighted item such as a wreath.

FIG. 3 is a 3-D rendering of the embodiment as illustrated in FIG. 1 and FIG. 2 with an inductive power transceiver.

FIG. 4 is a 3-D rendering of the embodiment as illustrated in FIG. 1 and FIG. 2 with a battery pack.

FIG. 5 is a 3-D rendering of an embodiment in which the over-the-door wreath hanger or wreath holder includes a DC battery holder.

FIG. 6 is an illustration of an exemplary lighted wreath supported by the hook portion of the wreath holder.

### DETAILED DESCRIPTION OF THE INVENTION

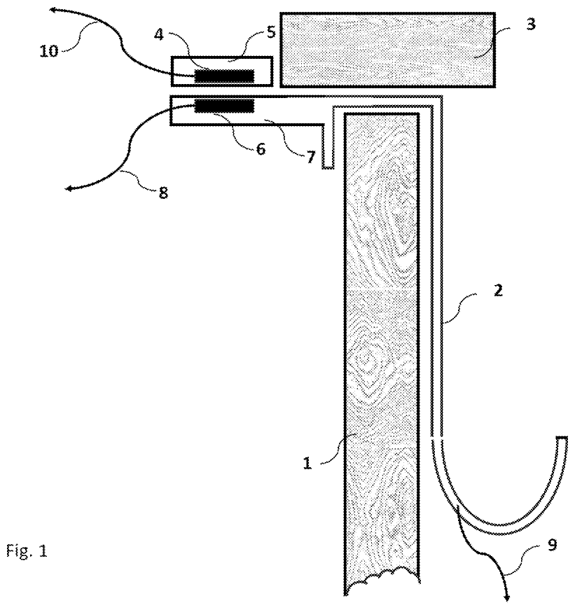

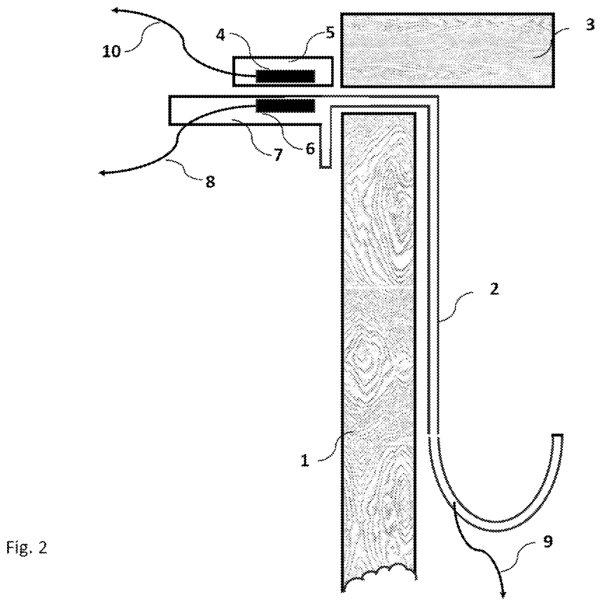

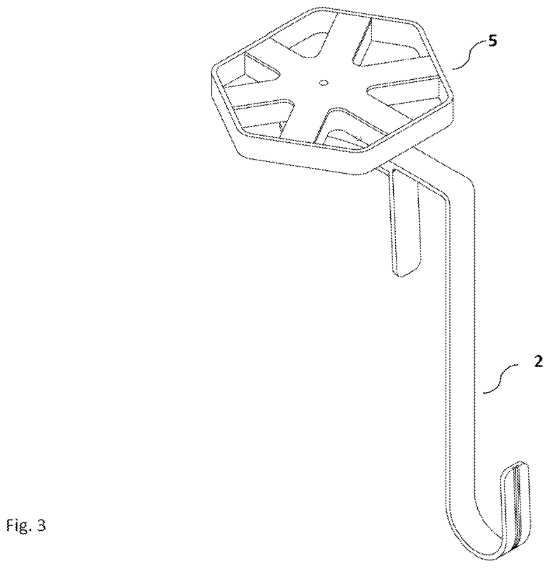

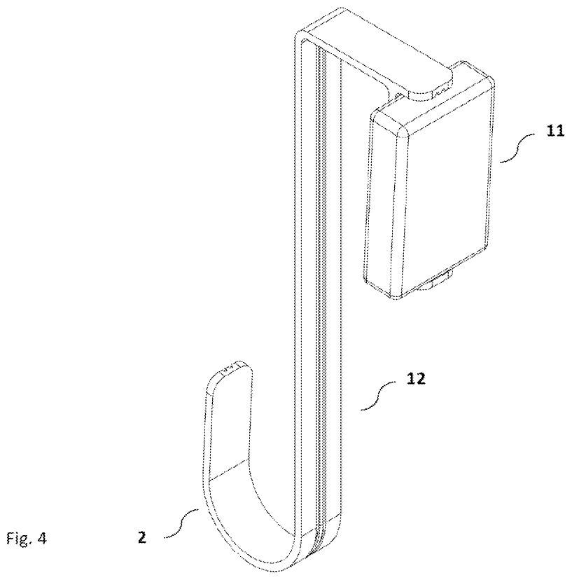

FIG. 1. Overview of innovation embodiment-an over-the-door hanger or holder for a decorative lighted item such as a wreath. The hanger includes wiring integral to carry electrical power from a power source on the interior side of the door to a power sink (e.g., the lights of the wreath) on the exterior side of the door. FIG. 1 shows a close-up cross-section view of the Door Panel Top Rail 1 on which the over-the-door wreath hanger or Wreath Holder 2 is placed and a close-up cross-section view of the Head Jamb of a Door Casing or Frame 3. An Inductive Power Transmitter 4 contained within a non-conductive Transmitter Housing or Enclosure 5 is mounted on the Head Jamb of the Door Casing or Frame 3 using a Temporary Adhesive (not shown) sufficient to secure the Housing or Enclosure 5 on the inside of the building. An Inductive Power Receiver 6 contained within the non-conductive Receiver Housing or Enclosure 7 is integrated into the Wreath Hanger or Wreath Holder 2. Electrical cord 8 runs from Receiver 6 through electrical wiring (not shown) integral to the Wreath Hanger or Wreath Holder 2 to a power sink (not shown) 9. Transmitter 4 and receiver 6 are contained within their respective non-conductive (plastic) housings. Electrical cord 10 supplies power to transmitter 4 from a power source such as a wall outlet (not shown).
FIG. 2. Innovation embodiment as described in FIG. 1 in which the Inductive Power Receiver 6 contained within the non-conductive Receiver Housing or Enclosure 7 may be moved and secured so the Inductive Power Receiver 6 and the Inductive Power transmitter 4 may be optimally aligned (for efficient power transfer) based on the relative positions of the Door Panel Top Rail 1 on which the over-the-door wreath hanger or Wreath Holder 2 is placed and the Head Jamb of a Door Casing or Frame 3 on which the Inductive Power Transmitter 4 contained within the non-conductive Transmitter Housing or Enclosure 5 is mounted.
FIG. 3. Provides a 3-D rendering of innovation embodiment as illustrated in FIG. 1 and FIG. 2 in which the over-the-door wreath hanger or Wreath Holder 2 is hung over the Door Panel Top Rail (not shown) and an Inductive Power Transmitter (not shown) contained within a non-conductive Transmitter Housing or Enclosure (not shown) is mounted on the Head Jamb of the Door Casing or Frame (not shown). An inductive power receiver (not shown) contained within the non-conductive receiver housing or enclosure 5 is integrated into the wreath hanger or Wreath Holder 2.
FIG. 4. Provides a 3-D rendering of a different innovation embodiment in which the over-the-door wreath hanger or wreath holder 2 is shown with the DC battery holder 11—which may or may not be a rechargeable DC battery pack (not shown)—secured to the interior-facing leg of the wreath hanger or wreath holder. In this view, note especially the recessed channel or groove 12 in which electrical wiring may be employed to convey power from the interior of the dwelling to the power sink on the exterior of the dwelling.

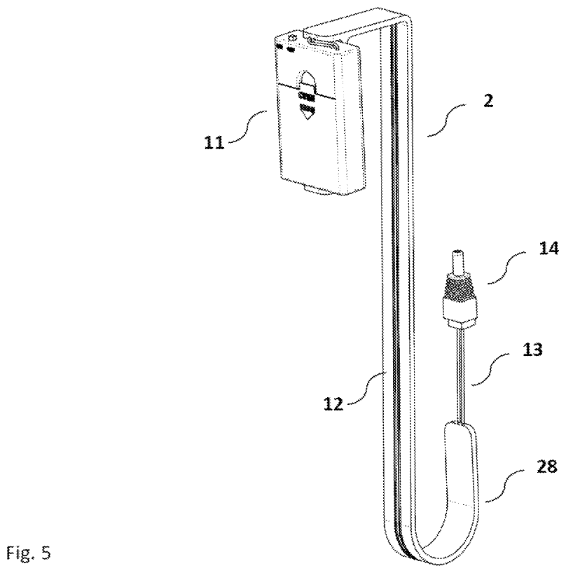

FIG. 5. Provides a 3-D rendering of innovation embodiment in which the over-the-door wreath hanger or wreath holder 2 is shown with the DC battery holder 11—or the rechargeable DC battery pack (not shown)—secured to the interior-facing leg of the wreath hanger or wreath holder. In this view, note especially the recessed channel 12 in which electrical wiring 13 integral to the wreath hanger or wreath holder 2 carries electrical power from the DC battery holder 11—or the rechargeable DC battery pack (not shown) to a power sink on the exterior side of the door via a connector such as-but not limited to-a Male Power “Plug” 14. The power sink (e.g., lights of a wreath or an electric candle) can be electrically coupled to the battery pack through a female jack (not shown) that couples to plug 14 that is proximate to hook portion 28 of wreath holder 2.

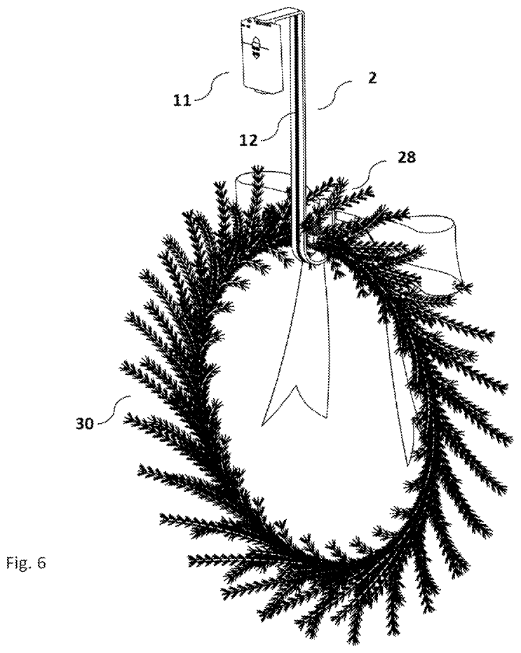

FIG. 6. Illustrates an exemplary lighted wreath 30 supported by hook portion 28 of wreath holder 2. The wreath or other lighted ornamentation can be physically supported by holder 2 such as by sitting on hook 28 or in another physical fashion such as by mating couplings at or near the outside end of holder 2 and on the ornamentation, in which case a hook may not be needed. Also shown is DC battery holder 11—or a rechargeable DC battery pack (not shown)—secured to the interior-facing leg of the wreath hanger or wreath holder. In this view is shown the recessed channel 12 in which electrical wiring integral to the wreath hanger or wreath holder 2 carries electrical power from the DC battery holder 11 or the rechargeable DC battery pack to a power sink on the exterior side of the door that is electrically coupled to the lights (not shown) of wreath 30.

Having described above several aspects of at least one example, it is to be appreciated that various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only, and the scope of the invention should be determined from proper construction of the appended claims, and their equivalents.

1. An integrated system for hanging an outdoor lighted decorative item on a door of a structure that has exterior exposure, and providing power to the item from indoors, comprising:
a power source;
a decorative item support structure that has an intermediate portion that is configured to hang on the top of the door, an exterior portion that extends in a first direction from the intermediate portion down along the exterior of the door and comprises a first support portion that is configured to carry the lighted decorative item, and an interior portion that extends in a second direction from the intermediate portion into the interior of the structure proximate the door and comprises a second support portion that is configured to support the power source; and
electrical wiring that carries electrical power from the power source to the lighted decorative item.

2. The system of claim 1 wherein the power source comprises a DC battery pack.

3. The system of claim 2 wherein the DC battery pack comprises rechargeable batteries.

4. The system of claim 1 wherein the power source comprises an inductive power receiver.

5. The system of claim 4 further comprising an inductive power transmitter that is configured to be held close to the inductive power receiver when the door is closed.

6. The system of claim 5 wherein the inductive power receiver and the inductive power transmitter are contained within separate non-conductive enclosures that are configured to be close to each other when the door is closed.

7. The system of claim 6 wherein the inductive power transmitter is configured to be supported by the head jamb of the door casing.

8. The system of claim 1 wherein the first support portion comprises a hook.

9. The system of claim 1 wherein the decorative item support structure is an integral plastic member.

10. The system of claim 9 wherein the second support portion comprises spaced horizontal parts that are configured to be located above and below a battery pack.

11. The system of claim 9 wherein the support structure defines a groove that extends from the second support portion to the first support portion, wherein the electrical wiring is located at least in part in the groove.

12. The system of claim 11 wherein the electrical wiring comprises a plug that is configured to mate with a jack carried by the decorative item.

13. The system of claim 1 wherein the intermediate portion comprises a generally “U” shaped integral plastic member that is configured to sit over the top of the door and extends downward along both the interior and exterior of the door.

14. An integrated system for hanging an outdoor lighted decorative item on a door of a structure that has exterior exposure, and providing power to the item from indoors, comprising:
a power source that comprises an inductive power receiver;
an inductive power transmitter that is configured to be held close to the inductive power receiver when the door is closed;
wherein the inductive power receiver and the inductive power transmitter are contained within separate non-conductive enclosures that are configured to be close to each other when the door is closed;
wherein the inductive power transmitter is configured to be supported by the head jamb of the door casing;
a decorative item support structure that comprises an integral plastic member that comprises:
an intermediate portion that is configured to hang on the top of the door, wherein the intermediate portion comprises a generally “U” shaped integral plastic member that is configured to sit over the top of the door and extends downward along both the interior and exterior of the door;
an exterior portion that extends in a first direction from the intermediate portion down along the exterior of the door and comprises a first support portion that is configured to carry the lighted decorative item; and
an interior portion that extends in a second direction from the intermediate portion into the interior of the structure proximate the door and comprises a second support portion that is configured to support the power source; and
electrical wiring that carries electrical power from the power source to the lighted decorative item.

15. The system of claim 14 wherein the support structure defines a groove that extends from the second support portion to the first support portion, wherein the electrical wiring is located at least in part in the groove.

16. The system of claim 15 wherein the electrical wiring comprises a plug that is configured to mate with a jack carried by the decorative item.
